(19) United States
(12) Patent Application Publication
(10) Pub. No.: US 2009/0301147 A1
(43) Pub. Date: Dec. 10, 2009

(54) Compound lock

(76) Inventor: Ping Jan Yang, Sinjhuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,350

(22) Filed: Aug. 28, 2008

(30) Foreign Application Priority Data
Jun. 6, 2008 (TW) 97210073

(51) Int. Cl. E05B 37/00

(52) U.S. Cl. 70/284

(57) ABSTRACT

A compound lock comprises: a shell, a combination locking mechanism, and a key locking mechanism. The shell has a panel providing a plurality of blocking walls protruding from the interior surface thereof. The combination locking mechanism is assembled in the shell, and has a plurality of locking disks. The locking disks each rotates on a sleeve and are penetrated by a shaft. The sleeves each is covered by a spring, one end of the sleeve forms a flange. The pushing piece provides a plurality of abutting portions. Both ends of the spring abut on the flange and the abutting portion respectively. Via this arrangement, when the locking disks are not turned to the correct positions, the blocking wall will block the flange of the sleeve. Users need to use the correct combination of numbers to lock the compound lock or change the correct combination of numbers.

### BACKGROUND OF THE INVENTION

1. Field of the Invention

The present invention is related to a compound lock, and more particular to a compound lock that has a combination locking mechanism and a key locking mechanism, wherein the two locking mechanisms can be simultaneously operated.

2. Description of Related Art

Generally, locks are comprehensively applied in our life. The conventional lock has a lock body and a key. Using the key locking or unlocking the lock body, people can prevent something being stolen.

However, if the keys are lost, the lock body of the key-locking lock will not be unlocked easily. Therefore, people will feel inconvenient when keys lost happened.

To solve the problem, a compound lock is developed, and the compound lock can be locked or unlocked by a combination locking mechanism or by a key locking mechanism. The combination locking mechanism has a plurality of locking disks, and the key locking mechanism has a turning head and a lock core. When the correct key is engaged with, the compound lock can is unlocked. And if the correct key is not available, the compound lock can also be unlocked by means of turning the locking disks to a correct combination of numbers, and turning the turning head to rotate the lock core. Because the compound locks are not necessary to be unlocked by the keys, they are convenient to use for the users. Above mentioned conventional compound locks provide good convenience, but still have some drawbacks: when the lock body is in the unlocked state, by using the turning head the correct combination of numbers is not needed for setting another new correct combination or for locking the lock body. Therefore, the number combinations of conventional compound locks installed in strongboxes or storages, can easily be changed by users, so that the owners of the strongboxes or storages may become unable to open their strongboxes or storages. In this way, the owner can only open the strongboxes or storages using the key locking mechanism, or needs to ask the service of a locksmith.

Consequently, because of the above technical defects, the inventor keeps on carving unflaggingly through wholehearted experience and research to develop the present invention, which can effectively improve the defects described above.

### SUMMARY OF THE INVENTION

The object of the present invention is to provide a compound lock. The compound lock can be unlocked by using a correct key or a correct combination of numbers. Moreover, the compound lock provides a further means to prevent itself being locked or the correct combination of numbers being changed by other people's indiscriminately turning the locking disks.

For achieving the object described above, the present invention provides a compound lock, comprising: a shell having a panel, the panel providing a through hole, a plurality of windows, and a plurality of blocking walls protruding from the interior surface of the panel; a combination locking mechanism assembled in the shell having a movable pushing piece and a plurality of locking disks, a plurality of openings being provided in the pushing piece, the locking disks corresponding to the windows and the openings respectively, the locking disks rotating on a plurality of sleeves respectively, and being penetrated by a shaft, a plurality of springs covering the sleeves respectively, the sleeves each forming a flat portion and a flange, a plurality of abutting portions being provided in the pushing piece, both ends of the spring abutting on the flange and the abutting portion respectively, the flange abutting on one side of the blocking wall, one end of the shaft forming a contacting portion; and a key locking mechanism assembled in the shell, corresponding to the through hole, and having a rotatable lock core, a rotatable lock core sleeve covering the lock core, and a turning head extending out of the shell, the lock core having a flat surface and an arc surface, the flat surface and the arc surface of the lock core both abutting the pushing piece on rotation, the lock core sleeve having a sliding groove and two concave portions being opposite to each other, the contacting portion of the shaft being movably received in the sliding groove and the concave portions.

The present invention has advantageous effects as follows. Via the shell, the combination locking mechanism, and the key locking mechanism cooperating one another, the invention provides users unlock the compound lock by using correct keys or the correct combinations of numbers. Furthermore, the invention provides a means to prevent the compound lock being locked or the correct combination of numbers being changed by indiscriminately turning the locking disks.

In order to further understand the characteristics and technical contents of the present invention, a detailed description is made with reference to the accompanying drawings. However, it should be understood that the drawings are illustrative only but not used to limit the present invention thereto.

### BRIEF DESCRIPTION OF THE DRAWINGS

FIG. 1 is a perspective view showing the compound lock of the present invention;

FIG. 2 is an exploded perspective view showing the compound lock of the present invention;

FIG. 3 is a perspective view showing the panel of the compound lock of the present invention;

FIG. 4 is a schematic diagram showing the rotation of the handle of compound lock of the present invention;

FIG. 5 is a schematic diagram showing the rotation of the key of compound lock of the present invention;

FIG. 6 is another schematic diagram showing the rotation of the key of compound lock of the present invention; and

FIG. 7 is more another schematic diagram showing the rotation of the key of compound lock of the present invention.

### DETAILED DESCRIPTION OF PREFERRED EMBODIMENTS

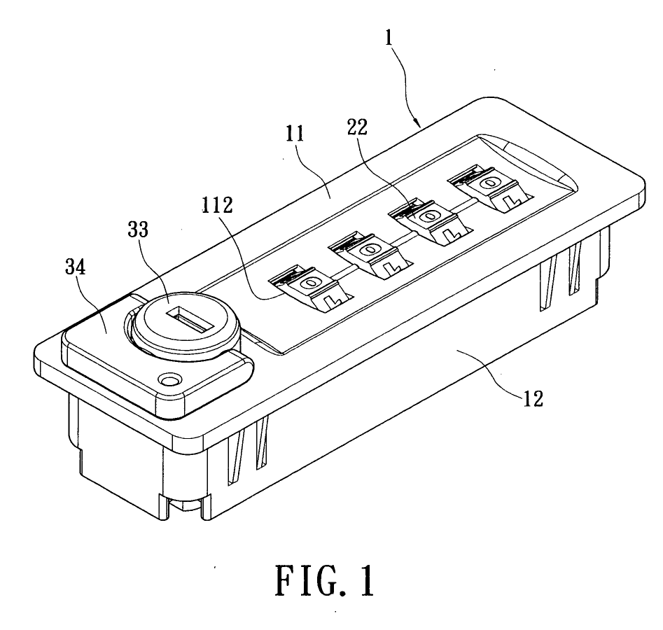

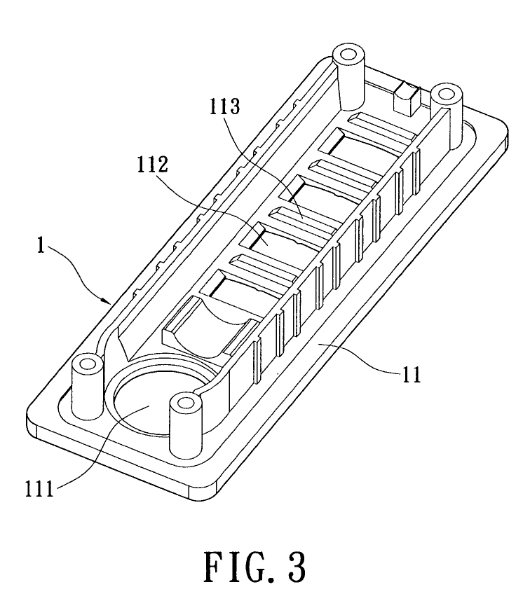

Please refer to FIGS. 1 to 4. The present invention is to provide a compound lock having a key locking mechanism 3 and a combination locking mechanism 2. The compound lock comprises a shell 1, a combination locking mechanism 2, and a key locking mechanism 3.

The shell 1 has a panel 11 and a base 12 which are engaged with each other. The panel 11 has a rectangular shape, and provides a through hole 111. The top of the shell 1 provides a plurality of windows 112, and the intervals between two neighboring windows 112 are identical. A plurality of rectangular blocking walls 113 are protruding from the interior surface of the panel 11, and each blocking wall 113 is located in the middle between two windows 112.

The base 12 further has a through hole 122 corresponding to the through hole 111 of panel 11. A plurality of elastic pieces 121 are protruding from base 12, and the intervals between two neighboring elastic pieces 121 are identical. The elastic pieces 121 are made of materials having sufficient elasticity, such as plastic or rubber. Each elastic piece 121 has a boss 1211 disposed in one end of the elastic piece 121. Each boss 1211 abuts on one plane of corresponding locking disk 22, thereby preventing the locking disk 22 freely rotating.

The combination locking mechanism 2 is assembled within the base 12, and has a pushing piece 21 and a plurality of locking disks 22. The pushing piece 21 and the locking disks 22 are disposed orderly from the base 12 toward the panel 11. Each locking disk 22 rotates on a sleeve 24, and a shaft 25 penetrates the locking disks 22 and the sleeves 24. Further, each sleeve 24 has a spring 23 encircling its front portion.

The pushing piece 21 is integrally formed from a metal plate being punched and bent, and is horizontally movably disposed within the base 12. Further, the pushing piece 21 has a plurality of openings 211; each interval between two neighboring openings 121 is the same. A plurality of abutting portions 212 are protruding from one side of the interior of the openings 21 respectively. The abutting portion 212 has a U-shape, and the sleeve 24 abuts on the abutting portion 212.

One end of the locking disks 22 passes through the corresponding opening 211 of the pushing piece 21, and the circumferential surfaces of the locking disks 112 are exposed through the corresponding windows 112 of panel 11. One end of the sleeve 24 forms a flat portion 241, a flange 242 neighboring to the flat portion 241, and a plurality of ribs 2421 extending from the circumferential surface of the flange 242. The flanges 242 can abut on the blocking walls 113 of the panel 11.

The abutting portions 212 of the pushing piece 21 are located in the middle of two sleeves 24 respectively, and movably abut on the circumferential surfaces of the sleeves 24. Both sides of the spring 23 abut on the abutting portion 212 and the flange 242 respectively, so that the sleeve 24 can return to their original positions after moving. Each abutting portion 212 also blocks the flange 242 of the neighboring sleeve 24.

The inner surface of the locking disk 22 provides a plurality of grooves 221, the grooves 221 are arranged peripherally and engaged with the ribs 2421, whereby the locking disks 22 can rotate on the sleeves 24 respectively.

Moreover, one end of the shaft 25 penetrates the base 12, and is encircled by another spring 26; the other end of the shaft 25 forms a semi-sphere-shaped contacting portion 251. Both ends of the spring 26 abut on the abutting portion 212 of the pushing piece 21 and the interior surface of the base 12.

The key locking mechanism 3 passes through the shell 1, and corresponds to the through hole 111 of the panel 11. The key locking mechanism 3 provides a general key lock function. In further explanations, the key locking mechanism 3 has a rotatable lock core 31, a rotatable lock core sleeve 32 covers the lock core 31, a turning head 33 extends out of the panel 11, and a handle 34 pivots on the turning head 33. The lock core 31 has a key hole 311, two symmetrical flat surfaces 312 and two symmetrical arc surfaces 313, wherein the flat surfaces 312 and the arc surfaces 313 are located on the circumferential surface of the lock core 31, and neighboring to each other. The flat surface 312 or the arc surface 313 can abut on one end of the pushing piece 21 while the lock core 31 is rotating, so that the pushing piece 21 can be moved horizontally. The bottom of the lock core 31 extends to the outside of the base 12, and further connects with a lock tongue (not shown). By the restoring force provided by the spring 26, the pushing piece 21 can return to its original position, meanwhile, the sleeves 24 can return to their original positions by the abutting portion 212.

The circumferential surface of the lock core sleeve 32 recesses a circular sliding groove 321 and two symmetrical concave portions 322 disposed in the sliding groove 321. The contacting portion 251 is movably received in the sliding groove 321 and the concave portions 322.

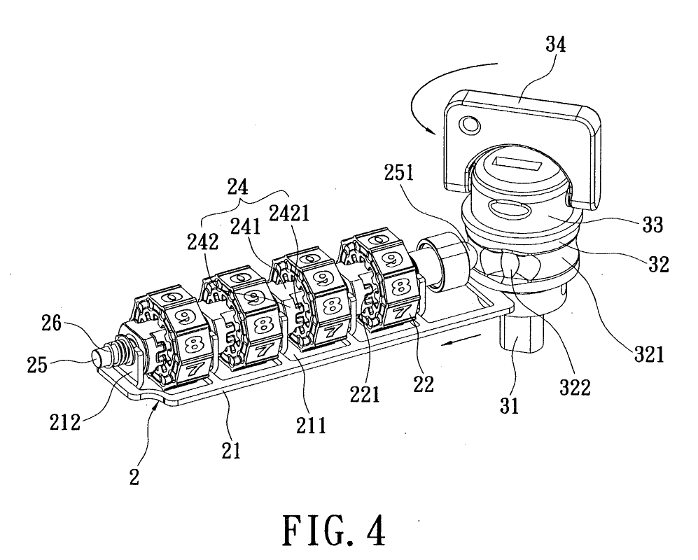

Please refer to the FIG. 4. When using the compound lock, users can turn the locking disks 22 to rotate the sleeves 24. After the locking disks 22 are turned to the correct numbers, which means the flat portions 241 of the sleeves 24 are faced upwards, users can further turn the handle 34. Then the sleeves 24 will disengage from the blocking walls 113 by the elastic force of the springs 23, and the ribs 2421 will also disengage from the grooves 221 of the locking disks 22.

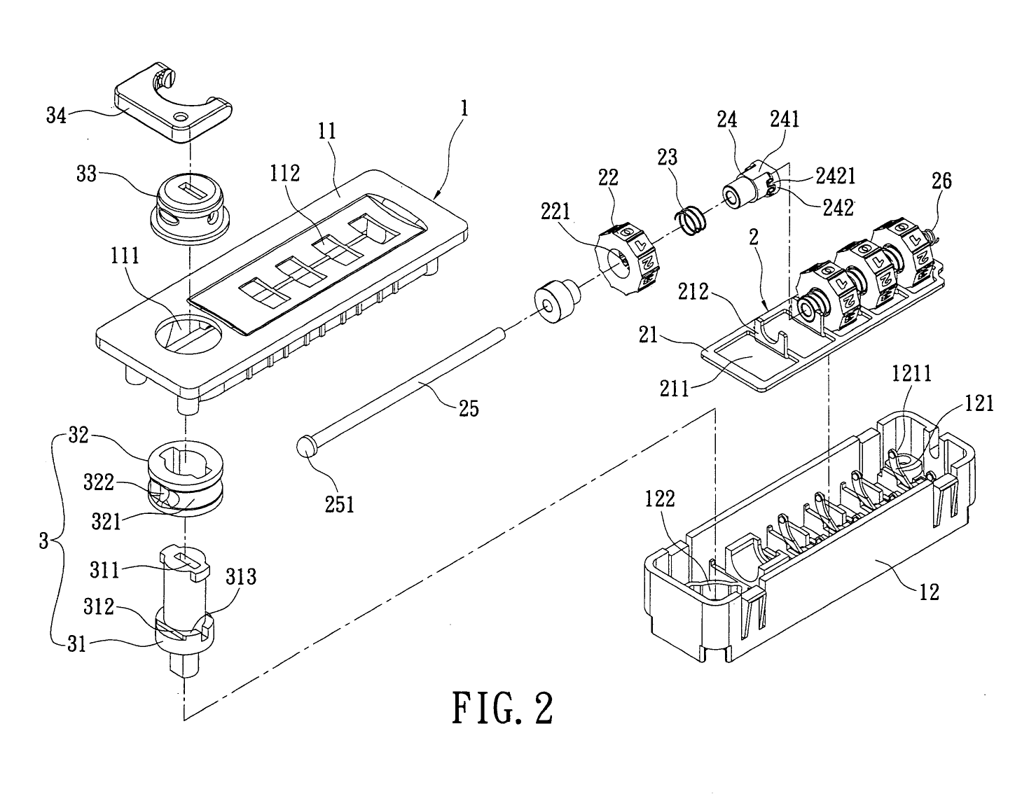

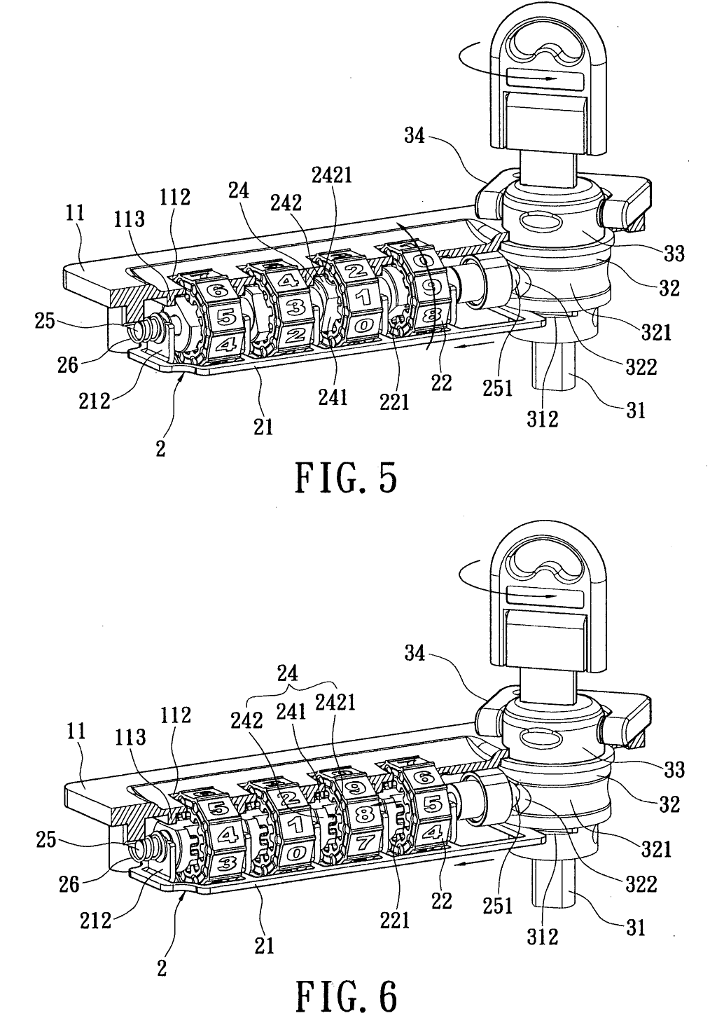

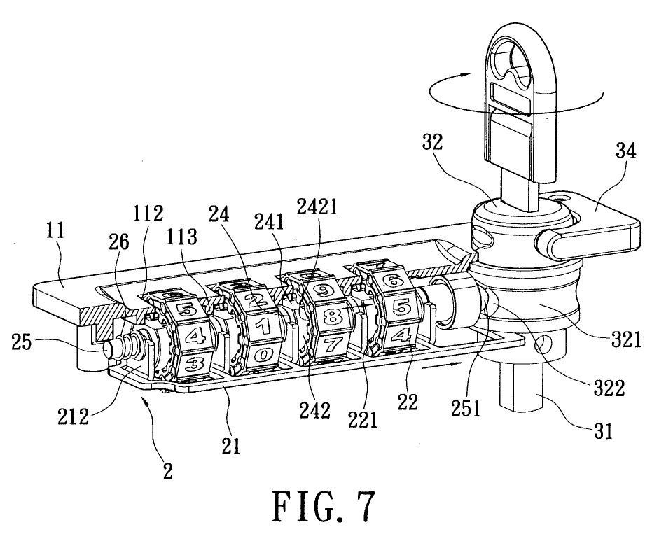

Please refer to the FIGS. 5 to 7 and 2; a further explanation of the operations of the invention is described in the following. When user inserts a correct key into the key hole 311 of the lock core 31, at this time the pushing piece 21 abuts on the flat surface 312 of the lock core 31. When user further turns the key to rotate the lock core 31, the pushing piece 21 will abut on the arc surface 313 and displace. Also, turning of the lock core 31 will simultaneously make the lock tongue unlock the compound lock. When the user turns the key to rotate the lock core 31 again, the pushing piece 21 will abut on the flat surface 312 and displace again. In the same time, the lock core 31 will bring the lock tongue locking the compound lock.

Moreover, when the user forgets the correct combination of the combination locking mechanism 2, the user can use the key to rotate the key locking mechanism 3 to displace the pushing piece 21, and rotate the locking disks 22 to the correct combination.

In conclusion, the compound lock of this invention provides users for unlocking the compound lock with the correct key or combination of numbers, thereby preventing users, who forgot bringing the key or the correct combination of numbers, being unable to unlock the compound lock. Also it provides a means that in the unlocked-state, indiscriminate turning of the locking disks 22 is incapable of setting a new correct combination of numbers. The locking disks 22 must be turned to the correct positions, then, the compound lock can be locked or a new combination of numbers can be set.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A compound lock, comprising:
a shell having a panel, the panel providing a through hole, a plurality of windows, and a plurality of blocking walls protruding from the interior surface of the panel;
a combination locking mechanism assembled in the shell having a movable pushing piece and a plurality of locking disks, a plurality of openings being provided in the pushing piece, the locking disks corresponding to the windows and the openings respectively, the locking disks rotating on a plurality of sleeves respectively, and being penetrated by a shaft, a plurality of springs covering the sleeves respectively, the sleeves each forming a flat portion and a flange, a plurality of abutting portions being provided in the pushing piece, both ends of the spring abutting on the flange and the abutting portion respectively, the flange abutting on one side of the blocking wall, one end of the shaft forming a contacting portion; and
a key locking mechanism assembled in the shell, corresponding to the through hole and having a rotatable lock core, a rotatable lock core sleeve covering the lock core, and a turning head extending out of the shell, the lock core having a flat surface and an arc surface, the flat surface and the arc surface of the lock core both abutting the pushing piece on rotation, the lock core sleeve having a sliding groove and two concave portions being opposite to each other, the contacting portion of the shaft being movably received in the sliding groove and the concave portions.

2. The compound lock according to claim 1, wherein the shell comprises a base engaged with the panel.

3. The compound lock according to claim 1, wherein another spring covers the shaft, both ends of the spring abut on the abutting portion and the interior surface of the shell respectively.

4. The compound lock according to claim 1, wherein the interior surface of the locking disks provides a plurality of grooves peripherally arranged, the sleeves each have a plurality of ribs extending from their peripheries, the locking disks rotate on the sleeves with the ribs engaging with the grooves.

5. The compound lock according to claim 1, wherein a plurality of elastic pieces protrude from the base, the elastic pieces each having a boss abutting on one side of the locking disk.

6. The compound lock according to claim 1, wherein a handle pivots on the turning head.
